(19) United States
(12) Patent Application Publication
(10) Pub. No.: US 2022/0129510 A1
(43) Pub. Date: Apr. 28, 2022

(54) REMOTE EQUIPMENT MONITORING AND CONTROL SYSTEM

(71) Applicant: Cornell Pump Company, Clackamas, OR (US)

(72) Inventors: Grayson Fleming, Clackamas, OR (US); Andrew Enterline, Troutdale, OR (US); Adam Lindeman, Portland, OR (US)

(21) Appl. No.: 17/467,491

(22) Filed: Sep. 7, 2021

Related U.S. Application Data
(60) Provisional application No. 63/104,054, filed on Oct. 22, 2020.

(51) Int. Cl. G06F 16/958; G06F 16/955; H04L 29/08; G16Y 40/35; G16Y 40/10

(52) U.S. Cl. CPC G06F 16/958; G06F 16/9566; G16Y 40/10; G16Y 40/35; H04L 67/12

(57) ABSTRACT

A device receives, from a user device, a request for a webpage, where the request is received in response to a scan of bar code affixed to a pump equipment or to an Internet of Things (IoT) device associated with the pump equipment. The device provides to the user device, upon receipt of the request, the webpage, where the webpage includes functionality for monitoring and controlling the pump or the IoT device. The device receives, as first user input from the user device, selection of an operational parameter of the pump and an adjustment to the selected operational parameter. The device sends, to the pump equipment or the IoT device, a message indicating the selected operational parameter and the adjustment to the selected operational parameter to control the selected operational parameter of the pump equipment.

### CROSS-REFERENCE TO RELATED APPLICATION

This application claims priority under 35 U.S.C. § 119, based on U.S. Provisional Application No. 63/104,054, filed Oct. 22, 2020, the disclosure of which is incorporated by reference herein.

### BACKGROUND OF THE INVENTION

Pumps have traditionally been monitored with two different techniques. With one of these techniques, pump data from pressure sensors, temperature sensors, and vibration sensors is sent to programmable logic controllers (PLCs) and fed to supervisory control and data acquisition (SCADA) systems. These types of systems are not cost effective or practical for many types of pump installations and/or portable pumps.

With a second technique, devices such as handheld vibration devices, temperature probes, pressure gauges, and the like, are used to perform periodic manual monitoring. Such periodic monitoring is typical for portable pumping systems and pumping systems without SCADA systems. This monitoring requires someone physically being present at the pump, the timing of which may not coincide with initial pump degradation or failure. Furthermore, periodic manual monitoring provides a measure of a pump condition only for the snap-shot in time for which it is taken.

### BRIEF DESCRIPTION OF THE DRAWINGS

FIG. 1 is a diagram of a network environment in which systems and methods described here may be implemented;

FIG. 2A illustrates an overview of the monitoring of operational parameters of pump equipment;

FIG. 2B illustrates an overview of the control of one or more operational parameters of pump equipment by a user device;

FIG. 3 is an exploded view of a monitoring/control device and a portion of the pump equipment in an implementation in which the monitoring/control device is attached to the pump equipment;

FIG. 4 is a front perspective view of the monitoring/control device according to the implementation of FIG. 3.

FIG. 5 is a block diagram of internal components of the monitoring/control device of FIGS. 2A and 2B;

FIG. 6 is a diagram of exemplary components of a device that may correspond to the web server, database, and/or user device of FIG. 1;

FIG. 7 is a flow diagram of an exemplary process for storing monitored pump operational parameter data in a database for retrieval and display at user devices;

FIG. 8 is an exemplary messaging/operations/data flow diagram associated with the process of FIG. 7;

FIGS. 9A and 9B are flow diagrams of an exemplary process for controlling selected pump operational parameters, retrieving and displaying monitored pump operational parameter data, and/or retrieving and displaying various types of user selected pump-related data;

FIG. 10 is a diagram depicting the scanning of a bar code affixed to a pump equipment;

FIGS. 11A-11C are exemplary messaging/operations/data flow diagrams associated with the process of FIGS. 9A and 9B; and

FIGS. 12-14 are diagrams of exemplary webpages that may be displayed by a browser at a user device during execution of the process of FIGS. 9A and 9B.

### DETAILED DESCRIPTION OF THE PREFERRED EMBODIMENTS

The following detailed description refers to the accompanying drawings. The same reference numbers in different drawings may identify the same or similar elements. Also, the following detailed description does not limit the invention.

Systems and methods described herein enable the monitoring and/or control of equipment, such as pump equipment, based on the scanning of a bar code associated with the equipment by a user device. As described herein, each pump or pump equipment may have a bar code affixed to it that a user may use a camera of a user device (e.g., a tablet or mobile smart phone) to “scan” and obtain an identifier encoded in the bar code. In some implementations, the identifier may include a Uniform Resource Locator (URL) associated with data (e.g., a webpage) stored at a server connected to a network, such as the Internet. A browser at the user device may use the URL to obtain, for example, a webpage from the server. The URL may map to the equipment and/or to an external device, such as an Internet of Things (IoT) device, that is associated with the equipment. The webpage may include functionality that enables the user device to monitor operational parameters of the equipment, retrieve pump-related data (e.g., Operations and Maintenance manuals, pump curves, assembly/maintenance videos, etc.), or exercise control of user-selected operational parameters of the equipment. For example, the webpage may include functionality for monitoring pressure, flow rate, vibration, temperature, and/or rotation speed or rotation direction of the pump equipment. As a further example, the webpage may include functionality for controlling starting or stopping of the pump equipment, for adjusting a rotation speed of the pump equipment, and/or for changing a rotation direction of the pump equipment.

In some implementations, the monitoring and/or control of the equipment may be performed using an IoT device that is external to the equipment. The IoT device may be located in proximity to the equipment and may connect to the equipment using a wired or wireless link(s). In some embodiments described herein, the IoT device may be affixed to the equipment and may connect to the equipment using, for example, a Modbus interface and/or another wired interface. The IoT device may monitor certain operational parameters via the Modbus/wired interface(s). The IoT device may additionally include sensors, such as vibration and temperature sensors, that may be used to monitor the equipment to which the IoT device is affixed.

Systems and methods described herein therefore enable easy identification of equipment, such as pump equipment, by scanning an associated bar code and engaging in quick access to equipment monitoring and control functions via a user device, such as a tablet or mobile smart phone, based on the bar code scan. The equipment monitoring and control functions provided by, for example, a webpage(s) accessed and displayed by a browser of the user device, enable user interaction with the webpage so as to select particular equipment operational parameters to remotely monitor, to select particular pump-related data to remotely access, and/or to select particular equipment operational parameters to remotely control.

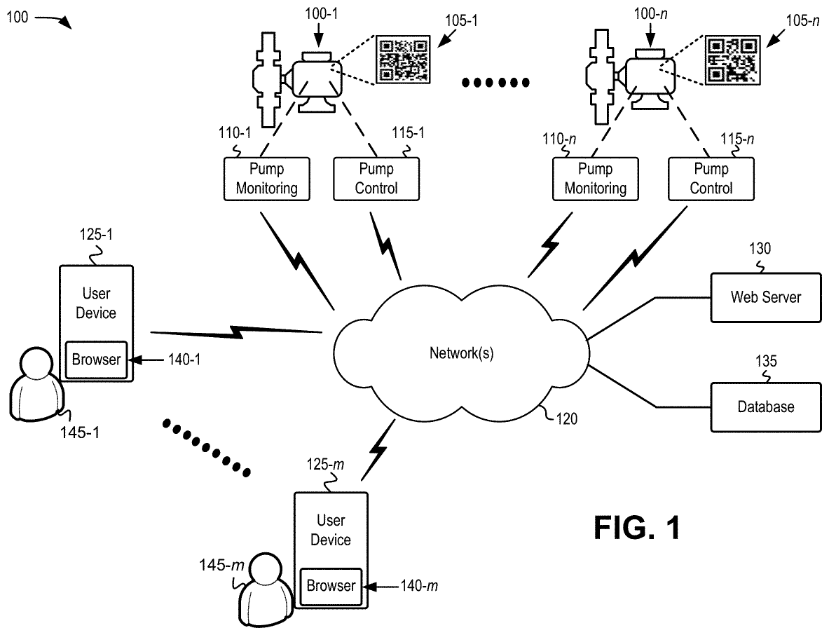

FIG. 1 is a diagram illustrating an exemplary network environment 100 in which systems and/or methods described herein may be implemented. As illustrated, network environment 100 may include pump equipment 100-1 through 100-n (collectively and individually referred to herein as “pump equipment 100”), a network 120, user devices 125-1 through 125-m (collectively and individually referred to herein as “user device 125”), a web server 130, and a database 135.

Pump equipment 100 may include a pump, engine, electric motor, or any other piece of equipment (e.g., rotating equipment) for which the user wishes to monitor the operation using sensors, or for which the user wishes to control one or more pump operational parameters. Pump equipment 100 may be distributed throughout a customer premises (not shown), such as an industrial, commercial, educational, agricultural customer premises, etc.

Each pump equipment 100 may be associated with a respective bar code 105. For example, bar code 105-1 may be associated with pump equipment 100-1, bar code 105-n may be associated with pump equipment 100-n, etc. In some circumstances, each bar code 105 may be affixed to an associated pump equipment 100. For example, a bar code 105 may be affixed to, or etched upon, a serial number tag of the pump equipment 100. Each bar code 105 may include any type of visual machine-readable code, such as for example, a matrix barcode (e.g., a Quick Response (QR) code). In one implementation, each bar code 105 may encode a Uniform Resource Locator (URL) that maps to the pump equipment 100, and which may be used to retrieve a webpage from web server 130 that includes functionality for monitoring and controlling the pump equipment 100.

As further shown, each pump equipment 100 may further be associated with a pump monitoring unit/device 110 and/or a pump control unit/device 115. For example, as shown, pump equipment 100-1 may be associated with a pump monitoring unit/device 110-1 and/or a pump control unit/device 115-1, and pump equipment 100-n may be associated with a pump monitoring unit/device 110-n and/or a pump control unit/device 115-n. Pump monitoring unit/device 110-1 and/or pump control unit/device 115-1 may connect to pump equipment 100-1 via a wired or wireless link(s). Pump monitoring unit/device 110-n and/or pump control unit/device 115-n may connect to pump equipment 100-n via a wired or wireless link(s). In some implementations, pump monitoring unit 110-1 and pump control unit 115-1 may be subcomponents of a single device located in proximity to pump equipment 100-1, and pump monitoring unit 110-n and pump control unit 115-n may be subcomponents of single device located in proximity to pump equipment 100-n. In other implementations, pump monitoring device 110-1 and pump control device 115-1 may be separate devices located in proximity to pump equipment 100-1, and pump monitoring device 110-n and pump control device 115-n may be separate devices located in proximity to pump equipment 100-n.

As described further herein, each pump monitoring unit/device 110 may monitor and collect sensor data (e.g., pump pressure, flow rate, rotation speed, rotation direction, vibration, temperature, location) associated with the operation of a respective pump equipment 100 and forward the monitored pump operational data to web server 130 via network(s) 120. Pump control unit/device 115 further receives pump control messages, via web server 130, that originated from user devices 125 and include user-originated instructions for adjusting selected pump operational parameters. Pump control unit/device 115 generates pump control instructions based on the received pump control messages and supplies the instructions to a connected pump equipment 100 to adjust the selected pump operational parameter(s).

Pump monitoring unit/device 110 and pump monitoring unit/device 115 may, either as a single device or as two separate devices, include an Internet of Things (IoT) device, a Machine Type Communication (MTC) device, a machine-to-machine (M2M) device, an enhanced MTC device (eMTC) (also known as Cat-M1), an end node employing Low Power Wide Area (LPWA) technology such as Narrow Band (NB) IoT (NB-IoT) technology, or some other type of wireless end node. According to various exemplary embodiments, monitoring unit/devices 110 and 115 may include hardware, such as a processor, application-specific integrated circuit (ASIC), a field-programmable gate array (FPGA), or a combination of hardware and software (e.g., a processor executing software) to execute various types of functions described further herein.

Network 120 may include one or more networks of various types including, for example, a wireless network, a Public Switched Telephone Network (PSTN), a Local Area Network (LAN), a wide area network (WAN), a metropolitan area network (MAN), an intranet, and/or the Internet. The wireless network may include a Public Land Mobile Network (PLMN) and/or a wireless LAN or WAN (e.g., Wi-Fi).

User devices 125 may each include any type of electronic device having a wired or wireless communication capability. User devices 125 may each be implemented as a mobile device, a portable device, or a stationary device. Each user device 125 may include, for example, a laptop, palmtop, desktop, or tablet computer; a cellular phone (e.g., a “smart” phone); a Voice over Internet Protocol (VoIP) phone; a smart television (TV); a device in a vehicle; a wireless telematics device; a wearable computer device (e.g., a wrist watch, eyeglasses, etc.) or an Augmented Reality/Virtual Reality (AR/VR) headset or glasses. User devices 125 may be configured to execute various types of software (e.g., applications, programs, web browsers, etc.). A user 145 may carry, use, administer, and/or operate each user device 125. For example, as shown in FIG. 1, a user 145-1 may use/operate user device 125-1 and a user 145-m may use/operate user device 125-m. Each of user devices 125 may execute a web browser 140 that enables a respective user 145 to access and view, and interact with the functionality of, webpages hosted by network devices connected to network 120, such as, for example, webpages hosted by web server 130. FIG. 1 depicts a browser 140-1 executed at user device 125-1 for use by user 145-1, and a browser 140-m executed at user device 125-m for use by user 145-m.

Web server 130 includes one or more network or computational devices to manage the receipt of monitored pump operational parameter data associated with pump equipment 100, and to manage requests from user devices 125 to view the pump operational parameter data and/or to control particular operational parameters of specific pump equipment 100. In some implementations, web server 130 may provide one or more types of browser-based user interfaces (e.g., webpages) to facilitate pump equipment monitoring and pump equipment control by user devices 125. Web server 130 may, for example, provide hosted webpages to user devices 125 upon user request.

In an alternative implementation, web server 130 may be replaced by an application server (not shown), and the browser 140 at each user device 125 may be replaced by an application (not shown). In this implementation, the application server, instead of the web server 130, may supply the monitored pump operational parameter data and/or the pump-related data, or initiate the pump equipment/IoT device control based on user input provided by the application executing at the user device 125. In yet another implementation both web server 130 and an application server may exist, and a user device 125 executing a browser 140 may communicate with the web server 130, and a user device 125 executing an application may communicate with the application server, to obtain the monitored pump operational data and/or the pump-related data, or to initiate the pump equipment/IoT device control.

In some circumstances, a user request to access a webpage(s) may involve a user 145 using his/her user device 125 to scan a barcode 105 associated with a pump equipment 100 to determine a URL encoded in the barcode 105. The URL may map to a particular pump equipment 100. The browser 140 of the user device 125 may then use the determined URL to access a webpage(s), hosted by web server 130, that relates to the pump equipment 100 corresponding to the URL. In some implementations, as described herein, the webpages may include a webpage having functionality that enables a user 145 to access and view monitored operational parameters (e.g., pressure, flow rate, rotation speed, rotation direction, vibration, temperature), associated with a particular pump equipment 100, that may be stored as operational parameter data in database 135. In additional implementations, the webpages may include a webpage having functionality that enables a user 145 to select a particular pump operational parameter of a pump equipment 100 for adjustment and control, as described further herein.

Database 135 includes a network or computational device that further includes memory for storing one or more data structures such as, for example, a database. The data structures may, for example, store monitored pump operational parameter data for each pump equipment 100. Web server 130, or user devices 125, may store received data in the data structure of database 135, or may retrieve specific requested data from the data structure of database 135.

The configuration of components of network environment 100 in FIG. 1 is for illustrative purposes. Other configurations may be implemented. Therefore, network environment 100 may include additional, fewer and/or different components/devices/networks that may be configured in a different arrangement from that depicted in FIG. 1. In practice, there may be more pump equipment 100, pump monitoring units/devices 110, pump control units/devices 115, and/or user devices 125 than are shown in FIG. 1. For example, there may be hundreds or thousands of pump equipment 100 across a large geographic area.

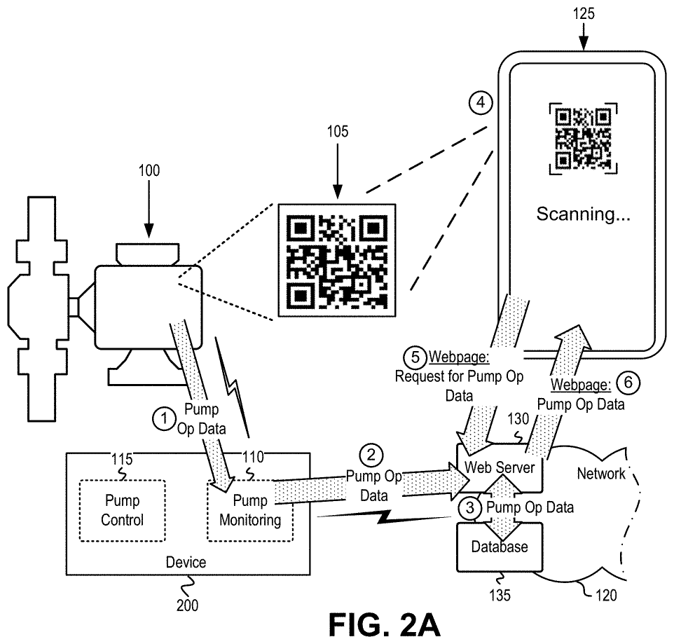

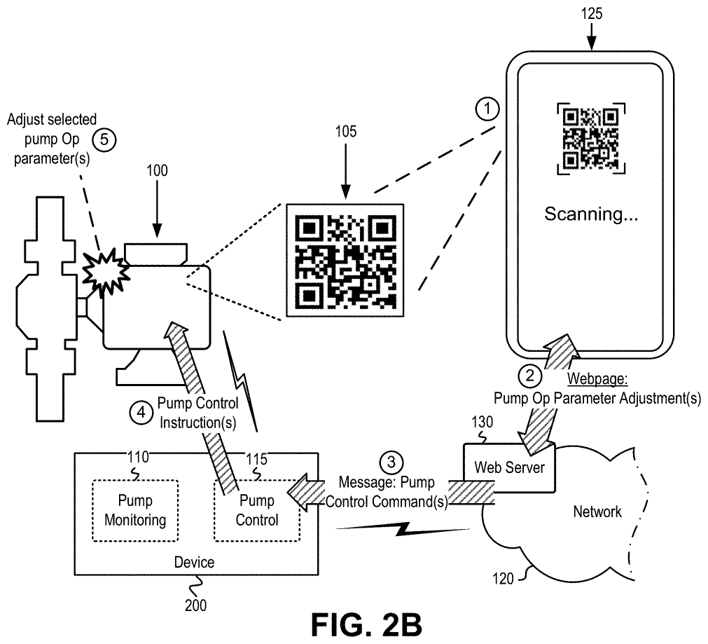

FIG. 2A illustrates an overview of the monitoring of operational parameters of a pump equipment 100. In the overview of FIG. 2A, pump monitoring unit 110 and pump control unit 115 are implemented within a single IoT device 200. The monitored pump operational parameters may include, for example, pump pressure, flow rate, rotation speed, rotation direction, vibration, and/or temperature of pump equipment 100. The monitored pump operational parameters may additionally include engine or Variable Frequency Drive (VFD) fault codes associated with pump equipment 100. As pump equipment 100 operates, pump monitoring unit 110 of device 200 obtains pump operational data from various sensors associated with the pump equipment 100 (identified with an encircled “1” in FIG. 2A). The various sensors may be disposed in pump equipment 100 and/or in device 200. Periodically, pump monitoring unit 110 generates a message that may include a time series of pump operational parameter data for the various sensors associated with the pump equipment 100. Pump monitoring unit 110 sends the message to web server 130 (identified with an encircled “2” in FIG. 2A), and web server 130 extracts the pump operational parameter data from the message and stores the data in a data structure database 135 (identified with an encircled “3” in FIG. 2A) for future retrieval.

Subsequently, a user device 125 scans a barcode 105 associated with a pump equipment 100 (identified with an encircled “4” in FIG. 2A) and determines a URL encoded within the barcode 105. A web browser (not shown) executing at the user device 125 uses the determined URL to obtain a webpage from web server 130. The webpage (not shown) includes functionality, described in further detail below, for displaying monitored operational parameter data associated with the pump equipment 100 that is further associated with the URL encoded in the scanned barcode 105. The webpage receives user input for selecting the particular monitored operational parameter data to be displayed to the user, generates a request for the appropriate pump operational parameter data from web server 130, and sends the request to web server 130 (identified with an encircled “5” in FIG. 2A). Upon receipt of the request, web server 130 retrieves the requested pump operational parameter data from database 135, generates a webpage to display the retrieved data, and sends the webpage to user device 125 (identified with an encircled “6” in FIG. 2A). The web browser (not shown) at user device 125 displays the requested pump operational parameter data to the user.

FIG. 2B illustrates an overview of the control of one or more operational parameters of a pump equipment 100 by a user device 125. As already described above with respect to FIG. 2A, in the overview of FIG. 2B, pump monitoring unit 110 and pump control unit 115 are implemented within the single IoT device 200. As shown, a user device 125 scans a barcode 105 associated with a pump equipment 100 (identified with an encircled “1” in FIG. 2B) and determines a URL encoded within the barcode 105. A web browser (not shown) executing at the user device 125 uses the determined URL to obtain a webpage from web server 130. The webpage (not shown) includes functionality, described in further detail below, for selecting an operational parameter(s) of the pump equipment 100 associated with the URL to control, and for receiving user input to adjust the selected operational parameter(s). In one implementation, the selected operational parameter may be a speed of the pump equipment 100, and the user input may adjust the pump equipment 100's rotation to a specific speed. In another implementation, the selected operational parameter may be a rotation direction of the pump equipment 100, and the user input may change the pump equipment 100's direction of rotation.

User device 125 may, via the accessed webpage, send pump operational parameter adjustments (identified with an encircled “2” in FIG. 2B) to web server 130 and web server 130, in turn, generates a message with a corresponding pump control command(s) and sends the message to pump control unit 115 of a device 200 (identified with an encircled “3” in FIG. 2B) that is associated with the target pump equipment 100. In one implementation, device 200 may be an IoT device that wirelessly connects to pump equipment 100. Upon receipt of the message from web server 130, pump control unit 115 extracts the pump control command(s) and transmits a corresponding pump control instruction(s) to the target pump equipment 100 (identified with an encircled “4” in FIG. 2B). Pump equipment 100 adjusts the selected pump operational parameter as specified by the pump control instruction(s) (identified with an encircled “5” in FIG. 2B).

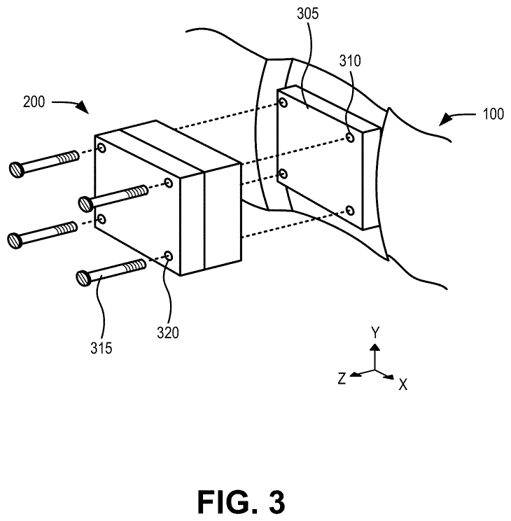

FIG. 3 is an exploded view of device 200 and a portion of pump equipment 100 in an implementation in which device 200 is attached to pump equipment 100. As shown in FIG. 3, pump equipment 100 may include a mounting surface 305 onto which device 200 may be attached. Mounting surface 305 may be a flat machined surface with mounting holes 310. In one implementation, mounting surface 305 may be on or part of the bearing housing of pump equipment 100. Mounting holes 310 may be configured to receive threaded mounting pins 315 (e.g., screws). In one implementation, mounting pins 315 may be threaded bolts separate from the housing of device 200. In another implementation, mounting pins 315 may be integrated into the housing of device 200. Mounting pins 315 may be inserted through holes 320 and secured in mounting holes 310 to attach device 200 to mounting surface 305. When attached to mounting surface 305, pump operational parameters, such a vibration and temperature, can be detected by sensors internal to device 200.

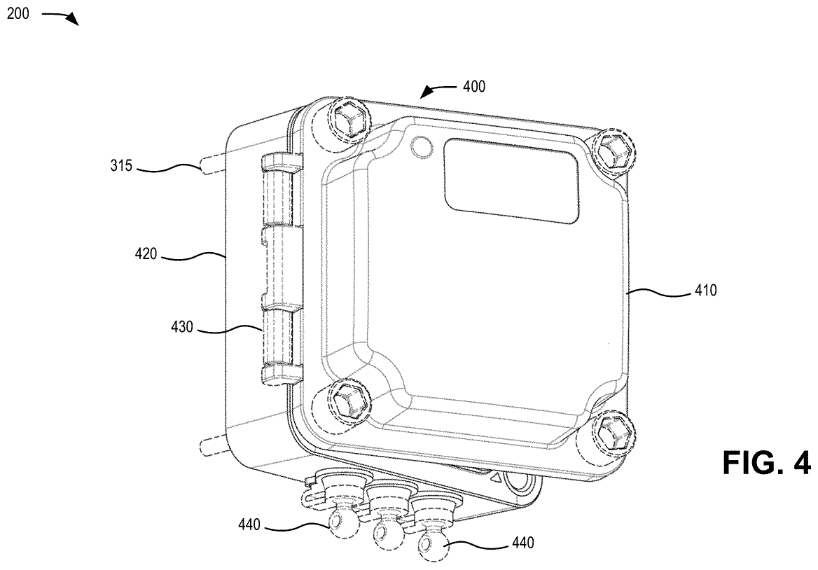

FIG. 4 is a front perspective view of device 200, shown with a partially open housing, according to the implementation of FIG. 3. Housing 400 of device 200 may include a front cover 410 and a base portion 420 connected by a hinge 430. In one implementation, housing 400 may provide a dust-resistant and water-spray or moisture resistant enclosure to protect internal components described further herein. In another implementation, housing 400 may meet one or more industrial standards for water-proof submersion. In one aspect, housing 400 may include integrated threaded mounting pins 315, such that monitoring device 200 may be attached to pump equipment 100 via the integrated screws.

Housing 400 may also include covered access ports 440, the covers of which may be removed/opened to provide access to connectors for external sensors. For example, connections internal to housing 400 may be used for wired connections to additional vibration sensors, pressure sensors, rotation speed sensors, temperature sensors, flow sensors, pressure sensors, or other external sensors. According to an implementation, one or more of covered access ports 440 may also provide for a Direct Current (DC) power connection to an external power source. In another implementation, connectors may be located outside of housing 400. Housing 400 may be compact in size and structurally rigid (e.g., hard plastic material) to allow for mounting on pump equipment 100. In one implementation, housing 400 may be less than 5 inches wide (e.g. x-axis of FIG. 3), 5 inches tall (e.g., y-axis), and 3 inches deep (z-axis). However, it should be understood that housing 400 may be larger or smaller based on the particular implementation.

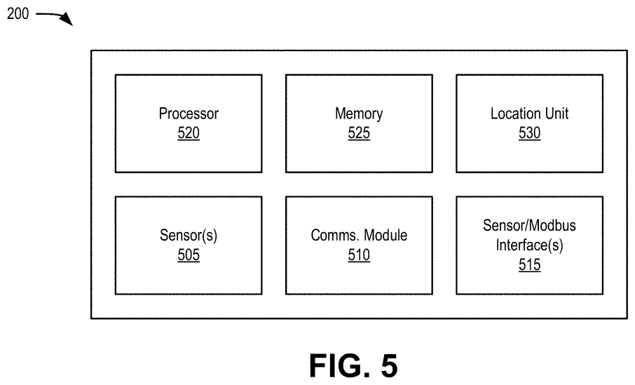

FIG. 5 is a block diagram of internal components of device 200. As shown in FIG. 5, device 200 may include a sensor(s) 505, a communications module 510, sensor/Modbus interfaces 515, a processor 520, a memory 525, and a location unit 530. The internal components may be enclosed, for example, within housing 400. According to an implementation, one or more components may be installed on a printed circuit board, an etched wiring board, or a printed circuit assembly. In one implementation, pump monitoring unit 110 of the device 200 of FIGS. 2A and 2B may be functionally implemented by processor 520 and memory 525 in conjunction with sensor(s) 505, communications module 510, sensor/Modbus interface(s) 515, and location unit 530. In another implementation, pump control unit 115 of the device 200 of FIGS. 2A and 2B may be functionally implemented by processor 520 and memory 525 in conjunction with communications module 510 and sensor/Modbus interface(s) 515.

Sensor(s) 505 may include one or more sensors for sensing pump operational parameters such as, for example, pump vibration and/or pump temperature. The sensor for measuring pump vibration may include accelerometers, signal amplifiers, and filters to detect and indicate sensed vibration in different directions. For example, the sensors for measuring pump vibration may include a set of three accelerometers to measure vibration along three respective axes (e.g., x-, y-, and z-axes of FIG. 3). In another implementation, the sensors for measuring vibration may measure vibration along two axes or one axis. According to one embodiment, the accelerometer may output a voltage or current proportional to the acceleration. The sensors for measuring temperature may detect a temperature within housing 400. The internal temperature of housing 400 may generally correspond to the temperature of the bearing housing of pump equipment 100. For example, changes in the bearing housing temperature will typically cause proportional temperature changes in the housing 400 of device 200. In one implementation, the sensors for measuring temperature may output an analog voltage value to processor 520 as a voltage output representing temperature (e.g., in degrees Fahrenheit or Celsius).

Communications module 510 permits device 200 to communicate with other devices, networks, systems, devices, and/or the like. According to implementations described herein, communication module 510 includes multiple wireless interfaces. For example, communications module 510 may include multiple transmitters and receivers, or transceivers. Communications module 510 may additionally include one or more antennas. For example, communications module 510 may include an array of antennas. Communications module 510 may operate according to one or more communication standards. Communications module 510 may include various processing logic or circuitry (e.g., multiplexing/de-multiplexing, filtering, amplifying, converting, error correction, etc.).

In some implementations, communications module 510 may include a broadband cellular module, a wireless personal area network (WPAN) module, and/or a radio module. The broadband cellular module may include a cellular radio transceiver, which may operate according to any known cellular standard, including the standards known generally as Third Generation Partnership Project (3GPP) Fourth Generation (4G), 4.5 Generation (4.5G), Fifth Generation (5G) mobile wireless standards, etc. The broadband cellular module may enable device 200 to conduct IoT communications with, for example, web server 130, or other network device(s) connected to network 120.

The WPAN module may include a radio transceiver for a wireless personal area network (e.g., using IEEE 802.15 standards or Bluetooth®). The WPAN module may enable the device 200 to transfer data to a user device 125 when user device 125 is within a relatively short distance of device 200 (e.g., up to about 30 feet). The radio module may include a radio transceiver operating in an unlicensed spectrum (e.g., 900 MHz, 2.4 GHz). For example, the radio module may be based on an RJ45 Ethernet interface, a point-to-point radio interface, or a point-to-multipoint radio interface. The radio module may enable communications between different devices 200, such as devices 200 in a same industrial complex, factory, educational institution, or agricultural space over a range of thousands of feet.

Sensor/Modbus interfaces 515 may include one or more interfaces to receive (e.g., via wired connections when covers of covered access ports 440 are removed) analog or digital data from sensors and/or Modbus-enabled devices that are external to device 200. For example, sensor/Modbus interface 515 may include interfaces to accept hard-wired inputs from pump pressure sensors, flow sensors, rotation speed sensors, etc. According to an implementation, multiple sensor interfaces 515 (e.g., 3, 5, 8, etc.) may be used with device 200. According to another implementation, sensor/Modbus interface 515 may include a Modbus interface to enable device 200 to act as a Modbus master for other Modbus-enabled devices. For example, a Modbus connection may be used to allow device 200 to receive and upload data from a motor or engine (e.g., pump driver) associated with pump equipment 100.

Processor 520 may include one or multiple processors, microprocessors, data processors, co-processors, application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, and/or some other type of component that interprets and/or executes instructions and/or data. Processor 520 may be implemented as hardware (e.g., a microprocessor, etc.), a combination of hardware and software (e.g., a SoC, an ASIC, etc.) and may include one or multiple memories (e.g., memory 525, cache, etc.).

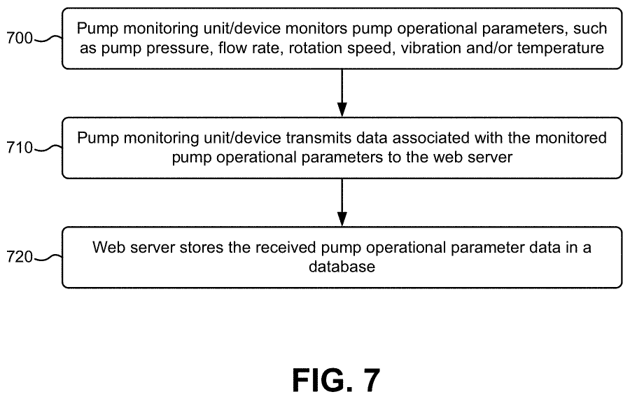

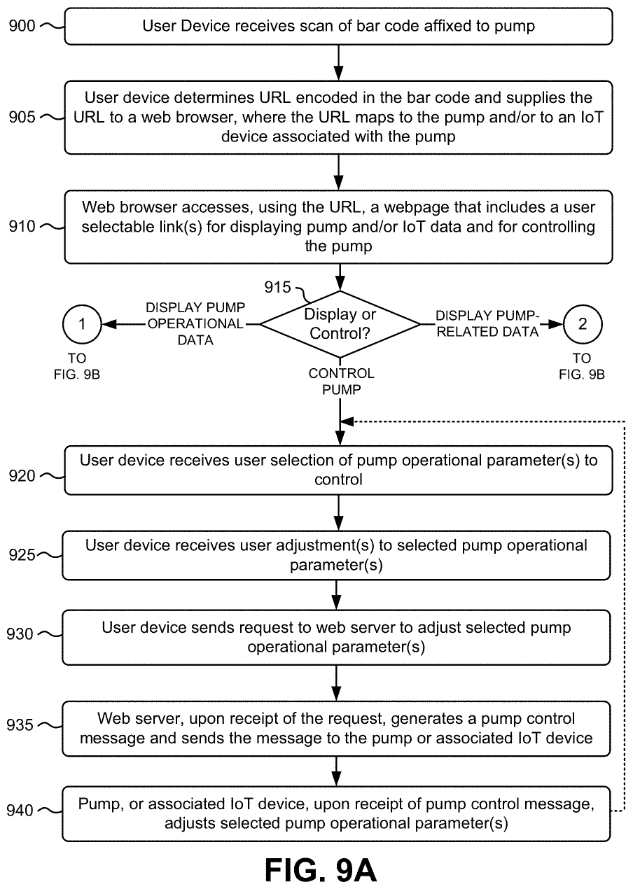

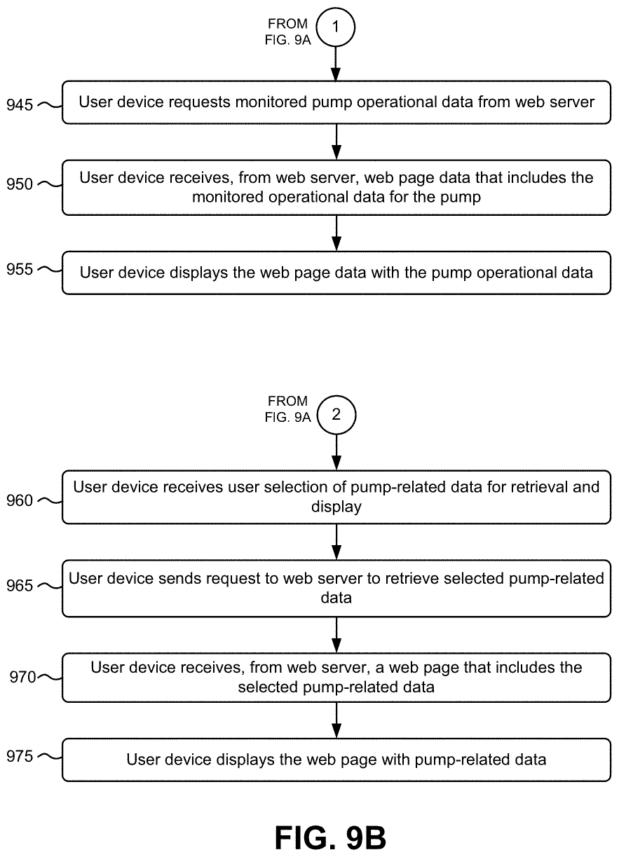

Processor 520 may control the overall operation or a portion of operation(s) performed by device 200. Processor 520 may collect sample readings from sensor(s) 505, sensors connected to sensor/Modbus interfaces 515, and/or location unit 530. Processor 520 may cause sample data to be sent to web server 130 on a periodic basis. Processor 520 may also be programmed to detect if readings from any sensors exceed a predetermined threshold value and generate an alert signal when a threshold is exceeded. Certain functions/operations performed by processor 520 are described further in connection with, for example, FIGS. 7, 9A and 9B below.

Memory 525 includes one or multiple memories and/or one or multiple other types of storage mediums. For example, memory 525 may include random access memory (RAM), dynamic random access memory (DRAM), cache, read only memory (ROM), a programmable read only memory (PROM), a static random access memory (SRAM), a single in-line memory module (SIMM), a dual in-line memory module (DIMM), a flash memory (e.g., a NAND flash, a NOR flash, etc.), and/or some other type of memory. Alternatively, or additionally, memory 525 may include a Micro-Electromechanical System (MEMS)-based storage medium, and/or a nanotechnology-based storage medium. Memory 525 may store data (e.g., from sensor(s) 505, location unit 530, sensors connected to sensor/Modbus interfaces 515, software, and/or instructions related to the operation of device 200.

Location unit 530 may communicate with an external positioning system to detect a location of device 200. For example, location unit 530 may include a location identification system (e.g., global positioning system (GPS) or another assisted location determining system).

Although FIG. 5 shows exemplary components of device 200, in other implementations, device 200 may contain fewer, different, differently arranged, or additional components than depicted in FIG. 5. Additionally, or alternatively, a component of device 200 may perform one or more other tasks described as being performed by another component of device 200.

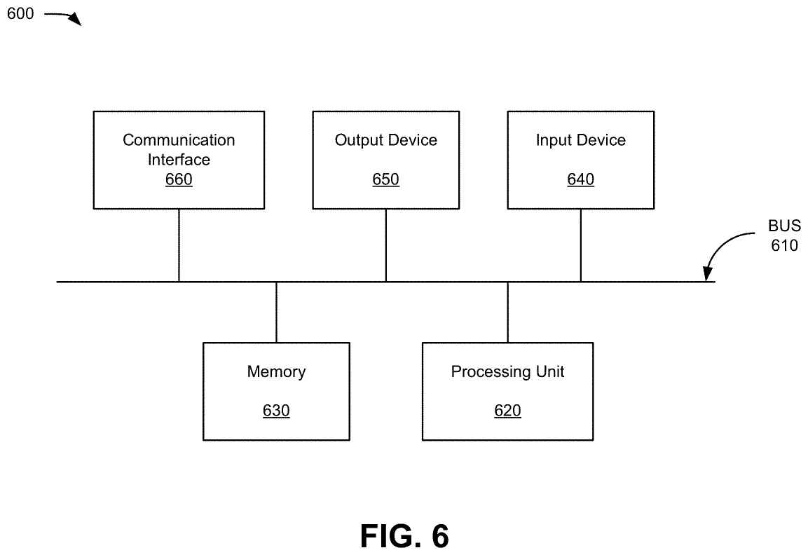

FIG. 6 is a diagram of exemplary components of a device 600 that may correspond to web server 130, database 135, or user device 125. As shown in FIG. 6, device 600 may include a bus 610, a processing unit 620, a memory 630, an input device 640, an output device 650, and a communication interface 660.

Bus 610 may permit communication among the components of device 600. Processing unit 620 may include one or more processors or microprocessors that interpret and execute instructions. In other implementations, processing unit 620 may be implemented as, or include, one or more ASICs, FPGAs, or the like.

Memory 630 may include a RAM or another type of dynamic storage device that stores information and instructions for execution by processing unit 620, a ROM or another type of static storage device that stores static information and instructions for the processing unit 620, and/or some other type of magnetic or optical recording medium and its corresponding drive for storing information and/or instructions.

Input device 640 may include one or more devices that permit an operator to input information to device 600, such as a keyboard, a keypad, a touch screen display, a mouse, a pen, a microphone, one or more biometric mechanisms, a camera (e.g., for scanning bar codes in the case of a user device 125), and the like. Output device 650 may include a device that outputs information to the operator, such as display, a speaker, etc.

Communication interface 660 may include a transceiver that enables device 600 to communicate with other devices and/or systems, such as other computing devices. Each of such other devices may include its respective communication interface 660 to achieve such communication.

As described herein, device 600 may perform certain operations in response to processing unit 620 executing software instructions stored in a computer-readable medium, such as memory 630. A computer-readable medium may include a tangible, non-transitory memory device. Memory 630 may be referred to herein as a “tangible non-transitory computer-readable medium,” a “non-transitory computer-readable medium,” or a “non-transitory storage medium.” A memory device may include space within a single physical memory device or spread across multiple physical memory devices. The software instructions may be read into memory 630 from another computer-readable medium or from another device via communication interface 660. The software instructions contained in memory 630 may cause processing unit 620 to perform processes described herein. Alternatively, hardwired circuitry may be used in place of or in combination with software instructions to implement processes described herein. Thus, implementations described herein are not limited to any specific combination of hardware circuitry and software.

Although FIG. 6 shows exemplary components of device 600, in other implementations, device 600 may contain fewer, different, differently arranged, or additional components than depicted in FIG. 6. In still other implementations, a component of device 600 may perform one or more other tasks described as being performed by another component of device 600.

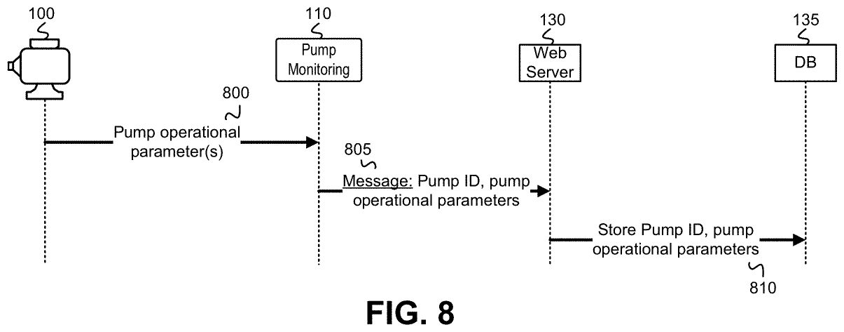

FIG. 7 is a flow diagram of an exemplary process for storing monitored pump operational parameter data in database 135 for retrieval and display at user devices 125. The exemplary process of FIG. 7 may be implemented by pump monitoring unit/device 110 in conjunction with web server 130 and database 135. The exemplary process of FIG. 7 is described below with reference to the exemplary messaging/operations/data flow diagram of FIG. 8. FIG. 8 provides simplified illustrations of messaging, operations, and/or data flows and is not intended to reflect every signal or communication exchanged between devices. The exemplary process of FIG. 7 may be selectively repeated (e.g., periodically) to provide current or recent monitored pump operational parameter data to web server 130 for storage in database 135.

The exemplary process may include pump monitoring unit/device 110 monitoring pump operational parameters, such as pump pressure, flow rate, rotation speed, rotation direction, vibration, and/or temperature (block 700) and transmitting the data associated with the monitored pump operational parameters to web server 130 (block 710). Pump monitoring unit/device 110 may monitor pump operational parameters, such as vibration and/or temperature, via sensor(s) 505. Pump monitoring unit/device 110 may monitor other pump operational parameters, such as pump pressure, flow rate, rotation speed, and rotation direction via sensor/Modbus interface(s) 515. Pump monitoring unit/device 110 may encapsulate a block of data corresponding to a monitored pump operational parameter(s) within a message and transmit the message to web server 130 over network(s) 120. FIG. 8 depicts pump monitoring unit/device 110 obtaining a pump operational parameter(s) from pump equipment 100, and generating a message 805 that includes an identification (ID) of the pump equipment 100 and data corresponding to the monitored pump operational parameters. Web server 130 stores the received pump operational parameter data in database 135 (block 720). As shown in FIG. 8, upon receipt of the message 805 from pump monitoring unit/device 110, web server 130 extracts the pump ID and pump operational parameters from the message 805 and stores 810 the pump ID and data associated with the monitored pump operational parameters in DB 135. The stored pump operational parameter data may be subsequently be retrieved by web server 130, or by another device, for provision to a requesting user device 125 for display to a user 145.

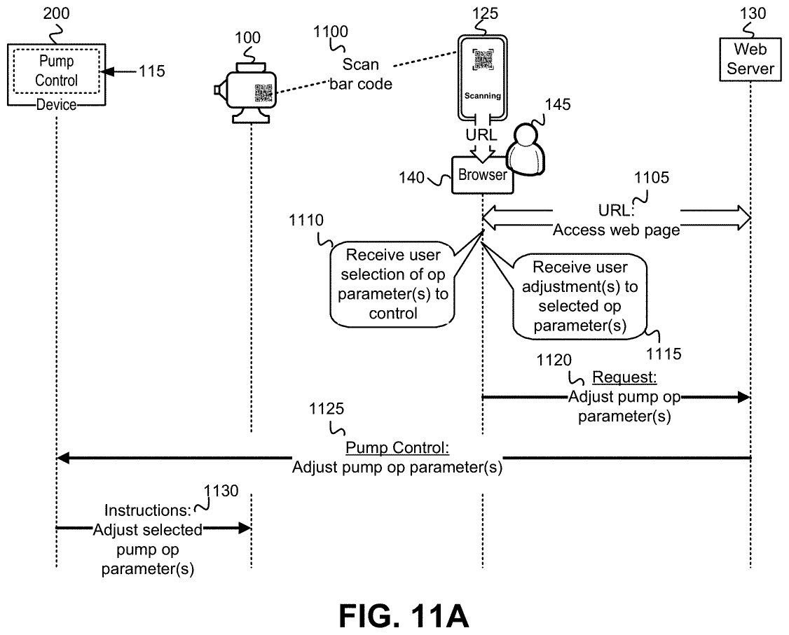

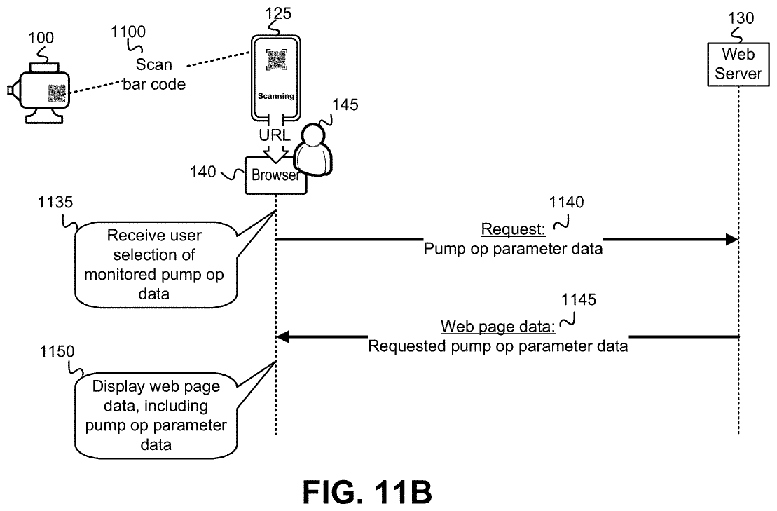

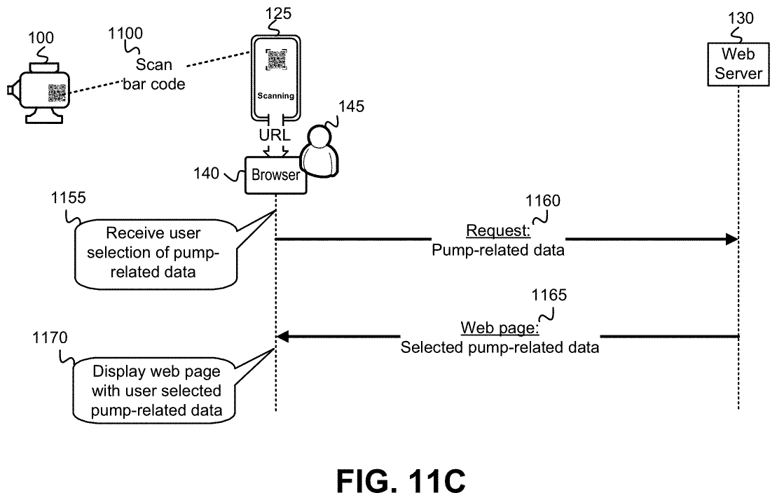

FIGS. 9A and 9B are flow diagrams of an exemplary process for controlling selected pump operational parameters, retrieving and displaying monitored pump operational parameter data, and/or retrieving and displaying various types of user selected pump-related data. The exemplary process of FIGS. 9A and 9B may be implemented by user device 125 in conjunction with web server 130, database 135, and/or pump equipment 100. The exemplary process of FIGS. 9A and 9B is described below with reference to the exemplary messaging/operations/data flow diagram of FIGS. 11A-11C. FIGS. 11A-11C provide simplified illustrations of messaging, operations, and/or data flows and are not intended to reflect every signal or communication exchanged between devices. The exemplary process of FIGS. 9A and 9B may be repeated upon each occurrence of a scan of a barcode 105 associated with a pump equipment 100 by a user device 125.

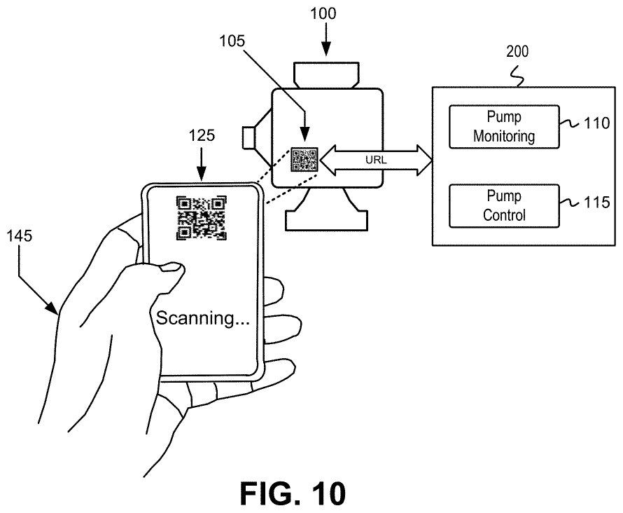

The exemplary process may include user device 125 receiving a scan of a bar code 105 affixed to a pump equipment 100 (block 900), determining a URL encoded in the bar code 105 and supplies the determined URL to a web browser 140 executed at user device 125, where the URL maps to the pump equipment 100 and/or to an IoT device associated with the pump equipment 100 (block 905). The user 145 of user device 125 may direct a camera of the device 125 towards a bar code 105 affixed to the pump equipment 100 and take a picture of the bar code 105 to “scan” the bar code 105. Bar code scanning functionality executed by user device 125 (e.g., an application) may extract a URL encoded in the bar code 105. The URL may map to the pump equipment 100 and/or to a device 200 associated with the pump equipment 100. FIG. 10 illustrates an example of a user 145 using a user device 125 to scan a bar code 105 affixed to a pump equipment 100. In the example shown, a URL obtained from the image scan of the bar code 105 maps to an IoT device 200 associated with the pump equipment 100. The IoT device 200, as shown, may include a pump monitoring unit 110 and/or a pump control unit 115.

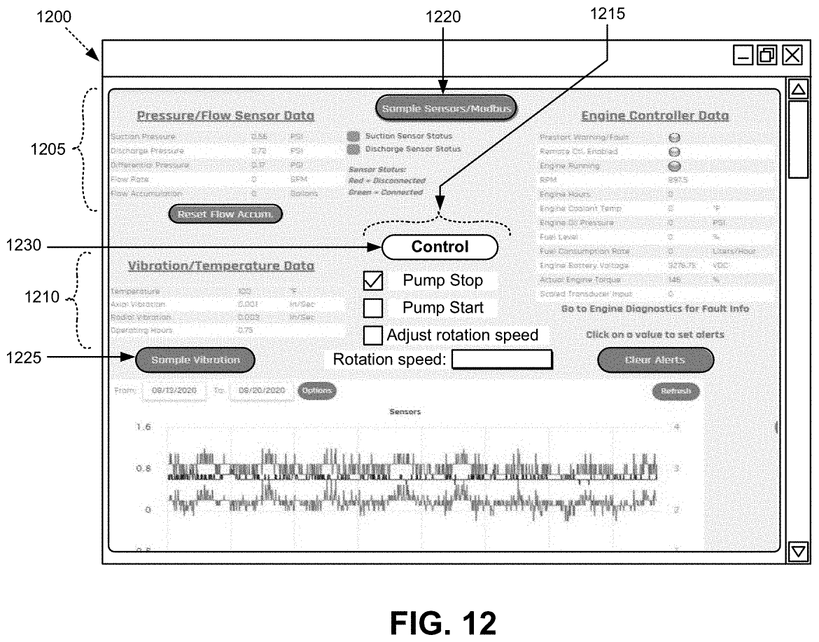

Web browser 140 accesses, using the URL, a webpage that includes a user selectable link(s) for displaying pump and/or IoT data and for controlling the pump equipment 100 (block 910). The URL serves as an address, in networks(s) 120, for retrieving a webpage that pertains to the pump equipment 100 that is mapped to the URL. Web browser 140 requests, from web server 130, the webpage that corresponds to the URL address. FIG. 11A illustrates user 145 scanning 1100 a bar code affixed to pump equipment 100 to supply a URL, encoded in the bar code, to the web browser 140 executing at user device 125. As further shown, the browser 140 at user device 125 uses the supplied URL to access 1105 a webpage stored at web server 130. In one implementation, the accessed webpage may include a Hypertext Markup Language (HTML) page. FIG. 12 further illustrates one example of a webpage 1200 that the web browser 140 may obtain from web server 130. Webpage 1200 may include a section 1205 for displaying pump pressure and/or flow rate monitored data for the pump equipment 100, a section 1210 for displaying vibration and/or temperature monitored data for the pump equipment 100, and a section 1215 for controlling, via user input to webpage 1200, selected operational parameters of the pump equipment 100.

Web browser 140 determines if display or control functionality has been selected via the accessed webpage (block 915). The user 145 of user device 125 may select display or control functionality from the accessed webpage using, for example, an input device 640 (e.g., a mouse or touch screen display). Using the example webpage 1200 of FIG. 12, the user 145 of user device 125 may select the “Sample Sensors/Modbus” link/button 1220 to retrieve and display monitored data from sensor/Modbus interface(s) 515 of IoT device 200 that is associated with the pump equipment 100, or may select the “Sample Vibration” link/button 1225 to retrieve and display monitored data from sensor(s) 505 of IoT device 200. Alternatively, the user 145 of user device 125 may select the “Control” link/button 1230 to enable remote control of an operational parameter of the pump equipment 100. As another alternative, the user 145 of user device 125 may select a link/button (not shown) for retrieving and display pump equipment-related data such as, for example, a description of the pump equipment, model and series information of the pump equipment, impeller trim and angle information of the pump equipment, a bill of materials (BOM) for the pump equipment, a pump curve for the operation of the pump equipment, assembly and/or maintenance videos of the pump equipment, manuals regarding assembly, maintenance and/or operation of the pump equipment, or parts ordering information for the pump equipment.

If control of the pump equipment 100 that corresponds to the scanned bar code 105 has been selected (“Control Pump”—block 915), then user device 125 receives a user selection of a pump operational parameter(s) to control (block 920), and receives user adjustment(s) to the selected pump operational parameter(s) (block 925). In some implementations, the control of the pump equipment 100 may include starting or stopping the pump equipment 100, adjusting the rotation speed of the pump equipment, or changing the direction of rotation of the pump equipment. For example, the user 145 of user device 125 may start the pump equipment 100 from an off operational status, and adjust the rotation speed of the pump equipment 100 to a specific speed. As another example, if the pump equipment 100 is already operating at a rotation speed x₁, then the user 145 of user device 125 may adjust the rotation speed to x₂, where x₂ is less than, or greater than, x₁. As a further example, if the pump equipment 100 is already operating with a clockwise rotation, then the user 145 of user device 125 may change the direction of rotation of the pump equipment 100 to a counterclockwise rotation (or vice versa, from counterclockwise rotation to a clockwise rotation). Referring to the example webpage 1200 of FIG. 12, the user 145 of user device 125 may select “Control” link/button 1230 and then select one of the checkboxes “Pump Stop,” “Pump Start,” and “Adjust rotation speed.” If the “Adjust rotation speed” checkbox is selected, then user 145 may additionally manually enter a specific rotation speed. FIG. 11A depicts browser 140 receiving 1110, via the user interface of the accessed webpage, a user selection of a pump equipment operational parameter(s) to control, and receiving 1115 a user adjustment(s) to the selected operational parameter(s).

User device 125 sends a request to web server 130 to adjust selected pump operational parameter(s) (block 930), and web server 130, upon receipt of the request from user device 125, generates a pump control message and sends the message to the pump equipment 100 or to the associated IoT device (block 935). The browser 140 generates a request to web server 130 that includes an indication of the pump operational parameter(s) selected by the user 145 for adjustment, and indicates the adjustment of the selected pump operational parameter(s) that is to be performed. For example, if the user 145 has selected “Adjust rotation speed” from webpage 1200, and entered a specific RPM value for the rotation speed, then browser 140 of user device 125 generates a request that includes an indication of the rotation speed adjustment and sends the request to web server 130 via network(s) 120. FIG. 11A shows browser 140 of user device 125 sending a request 1120 to web server 130 that identifies an adjustment to a particular pump operational parameter(s). Upon receipt of request 1120, as further shown in FIG. 11A, web server 130 sends a pump control message 1125 to IoT device 200 that includes one or more pump control commands for adjusting an operational parameter(s) of the pump equipment 100 in accordance with the request 1120 received from user device 125.

Pump equipment 100, or the associated IoT device 200, upon receipt of the pump control message, adjusts the selected pump operational parameter(s) (block 940). In an implementation in which pump equipment 100 receives instructions/commands directly from web server 130, pump equipment 100 extracts the pump control instructions from the received pump control message and adjusts the selected pump operational parameter(s) accordingly. In an implementation in which a device 200, such as described with respect to FIGS. 2A and 2B above, acts as an intermediary between web server 130 and pump equipment 100, device 200 supplies the pump control instructions to pump equipment 100 based on the content of the pump control message received from web server 130.

As an example, if pump equipment 100 is turned off, the pump control message may instruct the pump equipment 100 and/or device 200 to turn the pump equipment 100 on and start the pump rotating. As another example, if pump equipment 100 is already turned on, the pump control message may instruct the pump equipment to turn off such that the rotation speed decreases to zero. As a further example, if the pump equipment 100 is already turned on, and rotating at a particular pump rotation speed of x, the pump control message may instruct the pump equipment 100 to increase, or decrease, the pump rotation speed from speed x to a particular rotation speedy. In the example depicted in FIG. 11A, IoT device 200, upon receipt of the pump control message 1125 from web server 130, generates pump control instructions 1130 and sends the instructions 1130 to pump equipment 100 to adjust the pump operational parameter(s) selected by the user 145.

Subsequent to execution of block 940, the exemplary process may return to block 920 for user selection of an additional pump operational parameter(s) to control, and repeat blocks 920 through 940 for the new user selected pump operational parameter(s). For example, if the pump equipment 100 rotation speed was first adjusted to speedy in block 940, the user 140 of user device 125 may then adjust the rotation speed to speed z at a later time by repeating blocks 920 through 940. As a further example, if the pump equipment 100 rotation was first set to a first rotation direction D₁ in block 940, the user 140 of user device 125 may then change the direction of the rotation of pump equipment 100 to a second direction D₂ at a later time by repeating blocks 920 through 940.

If display of pump operational parameter data, associated with the pump equipment 100 that corresponds to the scanned bar code 105, has been selected (“Display Pump Operational Data”—block 915), then user device 125 requests monitored pump operation data from web server 130 (block 945). For example, referring to the example webpage of FIG. 12, the user 145 of user device 125 may select the “Sample Sensors/Modbus” link/button 1220 to retrieve and display monitored data from sensor/Modbus interface(s) 515 of IoT device 200 that is associated with the pump equipment 100, or may select the “Sample Vibration” link/button 1225 to retrieve and display monitored data from sensor(s) 505 of IoT device 200. Upon user selection of the display of pump operational parameter data, browser 140 of user device 125 generates a request that identifies the particular pump operational parameter(s) of the pump equipment 100 that is/are to be displayed at user device 125. FIG. 11B illustrates browser 140 of user device 125 receiving 1135 a user selection of a monitored pump operational data to be displayed, and browser 140 generating and sending a request 1140 to web server 130 that identifies the particular pump operational parameter(s) data which is to be supplied to browser 140 of user device 125 for display.

User device 125 receives, from web server 130, webpage data that includes the requested operational parameter data for the pump equipment 100 (block 950) and displays the webpage data, including displaying the received pump operational parameter data (block 955). Referring to the example webpage 1200 of FIG. 12, webpage data that includes pump pressure and/or pump flow rate data may be received from web server 130 and displayed in section 1205 of webpage 1200 by browser 140. Also referring to FIG. 12, webpage data that includes pump vibration and/or temperature data may be received from web server 130 and displayed in section 1210 of webpage 1200. FIG. 11B depicts web server 130 returning webpage data 1145, that includes the requested pump operational parameter data, to browser 140 at user device 125, and, upon receipt of the webpage data 1145, browser 140 displaying 1150 the received webpage data, including displaying the requested pump operational parameter data.

Referring back to FIG. 9A, if display of pump-related data, associated with the pump equipment 100 that corresponds to the scanned bar code 105, has been selected (“Display Pump-Related Data”—block 915), then user device 125 receives a user selection of pump-related data for retrieval and display (block 960). The pump-related data that may be selected by the user 145 of user device 125 may include, for example, a description of the pump equipment 100, model and series information of the pump equipment 100, impeller trim and angle information of the pump equipment 100, a bill of materials (BOM) for the pump equipment 100, a pump curve for the operation of pump equipment 100, assembly and/or maintenance videos of the pump equipment 100, manuals regarding assembly, maintenance and/or operation of the pump equipment 100, or parts ordering information for the pump equipment 100. FIG. 11C illustrates browser 140 of user device 125 receiving 1155 a user selection of pump-related data to be displayed, and browser 140 generating and sending a request 1160 to web server 130 that identifies the particular pump-related data to be supplied to browser 140 for display.

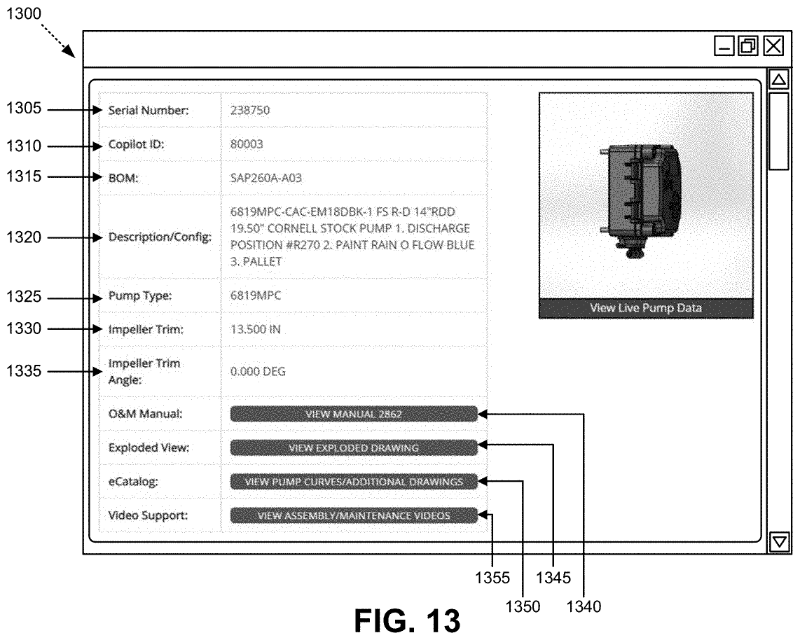

User device 125 sends a request to web server 130 to retrieve the selected pump-related data (block 965), receives, from web server 130, a webpage that includes the selected pump-related data (block 970), and displays the received webpage with the pump-related data (block 975). FIG. 13 depicts an example of a webpage 1300 that browser 140 may display when the user 145 selects “pump-related data” for the pump equipment 100 that corresponds to the scanned bar code 105. The example webpage 1300 shown in FIG. 13 displays multiple different items of pump-related data, including the pump equipment 100's serial number 1305, the ID number 1310 associated with device 200, the BOM 1315, a description 1320 of the pump equipment 100, a type 1325 of the pump equipment 100, an impeller trim 1330 of the pump equipment 100, an impeller trim angle 1335 of the pump equipment 100, an Operations & Maintenance (O&M) manual selection option 1340 for the pump equipment 100, an exploded drawing selection option 1345 for the pump equipment 100, a pump curve(s) selection option 1350 for the pump equipment 100, and an assembly/maintenance videos selection option 1355 for the pump equipment 100.

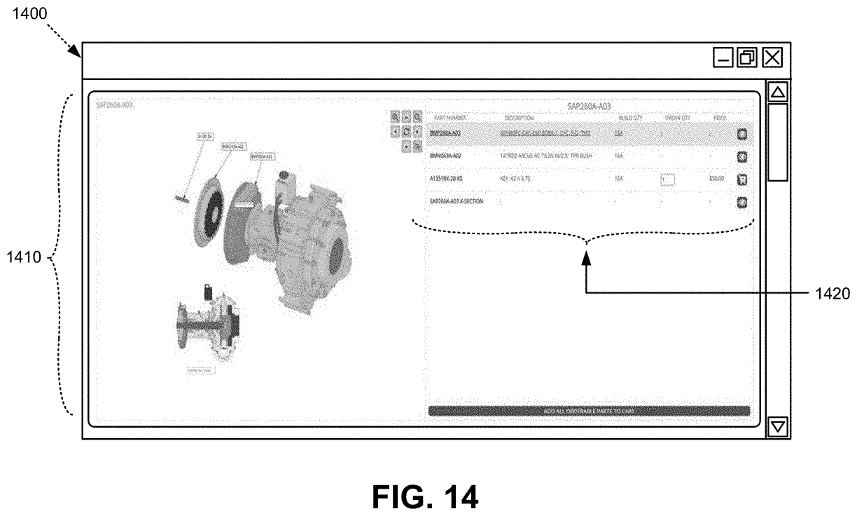

FIG. 14 depicts an example of a webpage 1400 that browser 140 may display when the user 145 desires to engage in parts ordering for the pump equipment 100. Webpage 1400 may display an exploded view 1410 of the pump equipment 100, and a parts ordering list 1420 that enables the user 145 to select particular parts of the pump equipment 100 that may be placed in a cart for order from the pump manufacturer or distributor. FIG. 11C further depicts web server 130 returning a webpage 1165, that includes the requested pump-related data, to browser 140 at user device 125, and, upon receipt of the webpage 1165, browser 140 displaying 1170 the received webpage, including displaying the requested pump-related data.

As set forth in this description and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration, but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

No element, act, or instruction used in the description of the present application should be construed as critical or essential to the invention unless explicitly described as such.

What is claimed is:

1. A device, comprising:
a communication interface; and
a processing unit configured to:
receive, from a user device, via the communication interface, a request for a webpage, wherein the request is received in response to a scan of bar code affixed to a pump equipment or to an Internet of Things (IoT) device associated with the pump equipment;
provide to the user device, upon receipt of the request, the webpage, wherein the webpage includes functionality for monitoring and controlling the pump or the IoT device;
receive, as first user input from the user device, selection of an operational parameter of the pump and an adjustment to the selected operational parameter; and
send, to the pump equipment or the IoT device via the communication interface, a message indicating the selected operational parameter and the adjustment to the selected operational parameter to control the selected operational parameter of the pump equipment.

2. The device of claim 1, wherein the operational parameter of the pump equipment comprises a rotation speed or rotation direction of the pump equipment and wherein the adjustment to the selected operational parameter comprises:
starting or stopping rotation of the pump equipment, or
changing the rotation speed or rotation direction of the pump equipment.

3. The device of claim 1, wherein, when starting the pump equipment, the adjustment to the selected operational parameter further comprises setting a specific rotation speed of the pump equipment.

4. The device of claim 1, wherein the processing unit is further configured to:
receive, as second user input from the user device, selection of a second operational parameter of the pump equipment for monitoring; and
obtain, from a database via the communication interface, monitored data associated with the selected second operational pump parameter; and
send, to the user device via the communication interface, the monitored data.

5. The device of claim 4, wherein the second operational parameter of the pump equipment comprises at least one of a pressure, a flow rate, a rotation speed, a rotation direction, a vibration, or a temperature of the pump equipment.

6. The device of claim 1, wherein the webpage further includes functionality for retrieving data associated with the pump equipment and wherein the data includes at least one of a description of the pump equipment, model and series information of the pump equipment, impeller trim and angle information of the pump equipment, a bill of materials (BOM) for the pump equipment, a pump curve for the pump equipment, assembly or maintenance videos of the pump equipment, manuals regarding assembly, maintenance or operation of the pump equipment, or parts ordering information for the pump equipment.

7. The device of claim 1, wherein the bar code comprises a matrix bar code that encodes a Uniform Resource Locator (URL), wherein the request from the user device includes the URL, and wherein the URL maps to the pump equipment or to the IoT device associated with the pump equipment.

8. A method, comprising:
obtaining, by a user device, a Uniform Resource Location (URL) based on a scan of a bar code associated with pump equipment;
requesting, by the user device using the URL, a webpage from a server, wherein the URL maps to the pump equipment or to an Internet of Things (IoT) device associated with the pump equipment;
displaying, upon receipt from the server, the webpage, wherein the webpage includes functionality for monitoring and controlling the pump or the IoT device;
receiving, as first user input to the webpage, selection of an operational parameter of the pump and an adjustment to the selected operational parameter; and
controlling, via the server, the selected operational parameter based on the adjustment to the selected operational parameter.

9. The method of claim 8, wherein the operational parameter of the pump equipment comprises a rotation speed or rotation direction of the pump equipment and wherein the adjustment to the selected operational parameter comprises:
starting or stopping rotation of the pump equipment, or
changing the rotation speed or the rotation direction of the pump equipment.

10. The method of claim 8, wherein, when starting the pump equipment, the adjustment to the selected operational parameter further comprises setting a specific rotation speed of the pump equipment.

11. The method of claim 8, further comprising:
receiving, as second user input to the webpage, selection of a second operational parameter of the pump equipment for monitoring; and
obtaining, by the user device from the server, monitored data associated with the selected second operational pump parameter; and
displaying, by the user device via the webpage, the monitored data.

12. The method of claim 11, wherein the second operational parameter of the pump equipment comprises at least one of a pressure, a flow rate, a rotation speed, a rotation direction, a vibration, or a temperature of the pump equipment.

13. The method of claim 8, wherein the webpage further includes functionality for retrieving data associated with the pump equipment and wherein the data includes at least one of a description of the pump equipment, model and series information of the pump equipment, impeller trim and angle information of the pump equipment, a bill of materials (BOM) for the pump equipment, a pump curve for the pump equipment, assembly or maintenance videos of the pump equipment, manuals regarding assembly, maintenance or operation of the pump equipment, or parts ordering information for the pump equipment.

14. The method of claim 8, wherein the bar code comprises a matrix bar code that encodes the URL.

15. A non-transitory computer-readable medium for a device, the non-transitory computer-readable medium containing instructions executable by at least one processor and comprising one or more instructions to cause the at least one processor to:
receive, from a user device, a request for a webpage, wherein the request is received in response to a scan of bar code affixed to a pump equipment or to an Internet of Things (IoT) device associated with the pump equipment;
provide to the user device, upon receipt of the request, the webpage, wherein the webpage includes functionality for monitoring and controlling the pump or the IoT device;
receive, as first user input from the user device, selection of an operational parameter of the pump and an adjustment to the selected operational parameter; and
send, to the pump equipment or the IoT device via the communication interface, a message indicating the selected operational parameter and the adjustment to the selected operational parameter to control the selected operational parameter of the pump equipment.

16. The non-transitory computer-readable medium of claim 15, wherein the operational parameter of the pump equipment comprises a rotation speed or rotation direction of the pump equipment and wherein the adjustment to the selected operational parameter comprises:
starting or stopping rotation of the pump equipment, or
changing the rotation speed or the rotation direction of the pump equipment.

17. The non-transitory computer-readable medium of claim 15, wherein, when starting the pump equipment, the adjustment to the selected operational parameter further comprises setting a specific rotation speed of the pump equipment.

18. The non-transitory computer-readable medium of claim 15, wherein the instructions further comprise one or more instructions to cause the at least one processor to:
receive, as second user input from the user device, selection of a second operational parameter of the pump equipment for monitoring; and
obtain, from a database, monitored data associated with the selected second operational pump parameter; and
send, to the user device, the monitored data.

19. The non-transitory computer-readable medium of claim 18, wherein the second operational parameter of the pump equipment comprises at least one of a pressure, a flow rate, a rotation speed, a rotation direction, a vibration, or a temperature of the pump equipment.

20. The non-transitory computer-readable medium of claim 15, wherein the webpage further includes functionality for retrieving data associated with the pump equipment and wherein the data includes at least one of a description of the pump equipment, model and series information of the pump equipment, impeller trim and angle information of the pump equipment, a bill of materials (BOM) for the pump equipment, a pump curve for the pump equipment, assembly or maintenance videos of the pump equipment, manuals regarding assembly, maintenance or operation of the pump equipment, or parts ordering information for the pump equipment.
